(19) United States
(12) Patent Application Publication
(10) Pub. No.: US 2020/0134578 A1
(43) Pub. Date: Apr. 30, 2020

(54) BLOCKCHAIN CONSENSUS SYSTEMS AND METHODS INVOLVING A TIME PARAMETER

(71) Applicant: Thunder Token Inc., Sunnyvale, CA (US)

(72) Inventors: Runting Shi, Sunnyvale, CA (US); Rafael Nat Josef Pass, Sunnyvale, CA (US); Tsz Hong Hubert CHAN, Sunnyvale, CA (US)

(21) Appl. No.: 16/664,727

(22) Filed: Oct. 25, 2019

Related U.S. Application Data
(60) Provisional application No. 62/750,765, filed on Oct. 25, 2018.

(51) Int. Cl. G06Q 20/06; G06Q 20/24

(52) U.S. Cl. CPC G06Q 20/065; H04L 67/104; G06Q 20/24

(57) ABSTRACT

The present blockchain systems and censuses protocols involve a committee of consensus nodes to notarize candidate blocks. The committee includes proposers and votes. A proposer can send an unnotarized proposal to the voters, and the voters can vote on an unnotarized proposal when the voter and the proposer have substantially the same freshest notarized chain. After receiving enough votes for the proposal, the proposal is notarized and added to the blockchain maintained by the systems and protocols. Epoch is provided to facilitate the operation of the systems and protocols. Epoch includes a value identifying a proposer and defines a duration in which the transmission and voting of the proposal can be completed. The time parameter can be used to determine the freshest notarized chain and the finalized chain. The finalized chain is determined by excluding a number of consecutive blocks with consecutive epoch values from the notarized chain.

### CROSS-REFERENCE TO RELATED APPLICATION

This application claims the benefit of U.S. Provisional Application 62/750,765 filed Oct. 25, 2018, the entirety of which is herein incorporated by reference.

### FIELD OF THE INVENTION

The present invention related to the field of blockchain consensus, and in particular, to blockchain consensus systems and protocols involving a time parameter that includes a value identifying a proposer node and that defines a period of time in which a propose communication and a vote communication can be completed.

### BACKGROUND OF THE INVENTION

Distributed ledgers provided in peer-to-peer networks, such as the blockchain used in the Bitcoin and Ethereum cryptocurrency systems, rely on a consensus system agreed-upon by the participants on the peer-to-peer network in order to add blocks of data to the ledger. In such systems, participants examine a proposed block in order to verify that they conform to a network agreed standard, rather than relying on a third-party trusted central authority to authorize the addition.

Existing consensus systems, however, have several problems. Proof of work systems require solving complex hashing algorithms using enormous, specialized hardware that consumes too much electricity. Such systems have led to a hashing-hardware arms race and creation of mining pools. Proof of stake systems are aimed to address the problems of proof of work systems. The idea behind proof of stake systems is to make control of the public ledger proportional to ownership stake of the digital currency. It is hoped that proof of stake systems will be more energy efficient and more appropriately distribute control over the public ledger. Such systems, however, can lead to creation of multiple chains or forks and there is no objective way to choose between them (Nothing-at-Stake problem). Practical Byzantine fault tolerance (PBFT) systems are another type of consensus systems. These systems are implemented through multiple rounds of participant voting, requiring messages in the network to be signed multiple times. This introduces computational overhead to calculate the signatures and disk-space overhead to store all the multiple signatures generated. Conventional consensus systems also have low throughput because they do not scale well to handle large transaction volumes. For example, Bitcoin and Ethereum can handle no more than 10 transactions per second. In contrast, Visa's transaction processing system can handle more than 200 transactions in the same amount of time.

Accordingly, there remains a need for blockchain consensus systems and protocols that are improved over the prior art.

### SUMMARY OF THE INVENTION

In accordance with principles of the invention, a system that implements a blockchain consensus protocol is contemplated. In one embodiment, the system comprises a plurality of node computers and each node computer in the plurality includes a processor, memory storing computer instructions executable by the processor, and a network interface operatively coupled to the processor and a communications network connecting the plurality of node computers. The plurality of node computers are configured to create a blockchain containing transactions. The plurality of node computers includes a committee of node computers comprising proposer node computers and voter node computers.

The system is configured to provide a time parameter to a proposal. The time parameter includes a value and defines a period of time. The value identifies a proposer node computer in the committee that sends a proposal and the period of time has a duration long enough for the committee to complete a notarization process.

The committee is configured to perform a notarization process. In the notarization process, the proposer node computer identified by the value of the time parameter is configured to prepare and send an unnotarized proposal, including transactions and a time parameter value in which the unnotarized proposal is sent, to the voter node computers in the committee. Each of the voter node computers in the committee is configured to sign the unnotarized proposal when the voter node computer has substantially the same record of the blockchain as the proposer node computer.

The system is configured to notarize the unnotarized proposal after the unnotarized proposal receives a threshold number of signatures and add the notarized proposal with the time parameter value to the blockchain.

The records being used to determine whether the voter node computer and the proposer node have substantially the same record are notarized chains that have the largest time parameter value.

The system is configured to determine a finalized chain from the notarized chain by excluding a number of consecutive blocks with constitutive time parameter values from the notarized chain and the finalized chain consists of blocks that are irreversible by node computers in the system.

In one embodiment, the largest time parameter value of the notarized chain in the proposer node computer and the largest time parameter value of the notarized chain in the voter node computer are the same.

In one embodiment, the largest time parameter value of the notarized chain in the proposer node computer is larger than the largest time parameter value of the notarized chain in the voter node.

In one embodiment, the number of consecutive blocks excluded by the system is 6.

In one embodiment, the system is configured to determine a finalized chain from the notarized chain by excluding a number of latest consecutive blocks with constitutive time parameter values from the notarized chain.

In one embodiment, the system is configured to determine a finalized chain from the notarized chain by excluding 6 latest consecutive blocks with constitutive time parameter values from the notarized chain.

In one embodiment, the threshold number of signatures is more than 50% of the total number of voter nodes in the committee.

In one embodiment, the threshold number of signatures is equivalent to a number of voter notes that together holds more than 50% of the total stake in the committee.

In one embodiment, the period of time is determined based on the number of node computers in the system.

In one embodiment, the system is configured to advance the time parameter value after the period of time expires. The voter node computers are configured to receive proposals from another proposer computer in the committee after the time parameter value advances.

In one embodiment, the proposer computer nodes and the voter node computers are selected based on a round robin policy.

In one embodiment, the system is further configured to send the finalized chain to a computer allowing the computer or the user of the computer to know that the transaction successfully went through the blockchain system. The finalized chain appears as a series transactions or records on a display of the computer showing the submitted transactions and digital signatures of the node computers that submitted the transactions.

In one embodiment, the transactions include cryptocurrency transactions, bank transactions, credit card transactions, non-monetary transactions, transactions used to create or execute computer instructions, or transactions based on a combination thereof.

In accordance with principles of the invention, a computer-implemented method or blockchain consensus protocol is contemplated. The method comprises implementing a blockchain consensus software application in a plurality of node computers. Each node computer in the plurality includes a processor, memory storing computer instructions executable by the processor, and a network interface operatively coupled to the processor and a communications network connecting the plurality of node computers. The application configures the plurality of node computers to create a blockchain containing transactions and to form a committee of node computers comprising proposer node computers and voter node computers.

The blockchain consensus software application includes computer instructions stored in the memory that are executable by the processor to perform computer-implemented steps comprising providing a time parameter to a proposal. The time parameter includes a value and defines a period of time. The value identifies a proposer node computer in the committee that sends a proposal and the period of time has a duration long enough for the committee to complete a notarization process. The steps also comprise performing a notarization process including allowing the proposer node identified by the time parameter value to prepare and send an unnotarized proposal, including transactions and a time parameter value in which the unnotarized proposal is sent, to the voter node computers in the committee, allowing each of the voter nodes in the committee to sign the unnotarized proposal when the voter node computer has substantially the same record of the blockchain as the proposer node computer, notarizing the unnotarized proposal after the unnotarized proposal receiving a threshold number of signatures, and adding the notarized proposal with the time parameter value to the blockchain.

The records being used to determine whether the voter node computer and the proposer node have substantially the same record are notarized chains that have the largest time parameter value.

The steps further comprise determining a finalized chain from the notarized chain by excluding a number of consecutive blocks with constitutive time parameter values from the notarized chain, wherein the finalized chain consists of blocks that are irreversible by node computers in the system.

In one embodiment, the largest time parameter value of the notarized chain in the proposer node computer is the same as or larger than the largest time parameter value of the notarized chain in the voter node.

In one embodiment, the number of consecutive blocks excluded by the system is 6.

In accordance with principles of the invention, a non-transitory computer readable medium embodiment is contemplated. The medium stores an application that can cause a computer to execute a process. The process comprises implementing a blockchain consensus software application in a plurality of node computers. Each node computer in the plurality includes a processor, memory storing computer instructions executable by the processor, and a network interface operatively coupled to the processor and a communications network connecting the plurality of node computers. The application configures the plurality of node computers to create a blockchain containing transactions and to form a committee of node computers comprising proposer node computers and voter node computers.

The blockchain consensus software application includes computer instructions stored in the memory that are executable by the processor to perform computer-implemented steps comprising providing a time parameter to a proposal. The time parameter includes a value and defines a period of time. The value identifies a proposer node computer in the committee that sends a proposal and the period of time has a duration long enough for the committee to complete a notarization process. The steps also comprise performing a notarization process comprising allowing the proposer node identified by the time parameter value to prepare and send an unnotarized proposal, including transactions and a time parameter value in which the unnotarized proposal is sent, to the voter node computers in the committee, allowing each of the voter nodes in the committee to sign the unnotarized proposal when the voter node computer has substantially the same record of the blockchain as the proposer node computer, notarizing the unnotarized proposal after the unnotarized proposal receiving a threshold number of signatures, and adding the notarized proposal with the time parameter value to the blockchain; The records being used to determine whether the voter node computer and the proposer node have substantially the same record are notarized chains that have the largest time parameter value.

The steps further comprise determining a finalized chain from the notarized chain by excluding a number of consecutive blocks with constitutive time parameter values from the notarized chain, wherein the finalized chain consists of blocks that are irreversible by node computers in the system.

In one embodiment, the largest time parameter value of the notarized chain in the proposer node computer is the same as or larger than the largest time parameter value of the notarized chain in the voter node.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 depicts an illustrative blockchain system in accordance with some embodiments of the present invention;

FIG. 2 depicts an illustrative block including an epoch value provided by the blockchain system in accordance with some embodiments of the present invention;

FIG. 3 depicts illustrative notarized chain, freshest notarized chain, and finalized chain in accordance with some embodiments of the present invention; and

FIG. 4 depicts an illustrative voting rule in accordance with some embodiments of the present invention.

### DETAILED DESCRIPTION OF THE INVENTION

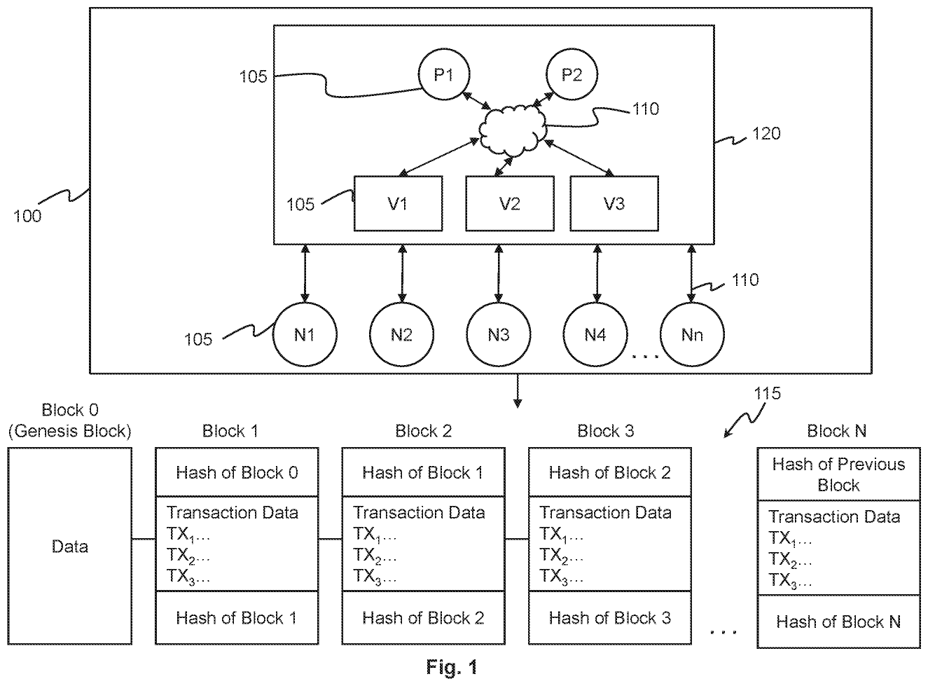

FIG. 1 depicts an illustrative blockchain system 100 of the present invention. The blockchain system 100 includes a plurality of node computers 105 and a communications network 110 connecting the plurality of node computers 105. Each node computer in the plurality includes a processor, memory storing computer instructions executable by the processor, and a network interface operatively coupled to the processor and the communications network 105 which may be a wide area network such as the Internet. The blockchain system 100 is implemented with a blockchain consensus software application (blockchain consensus protocol). The blockchain consensus software application is adapted to connect to the plurality of node computers 105 through the communications network 110. The blockchain consensus software application configures the blockchain system 100 to operate in the manners described in this application. Communication between node computers 105 are by way of digital messages constructed by the node and transmitted to other node computers using packets over a communications network.

Through the software application, node computers 105 can operate to reach a consensus on adding transactions to an overall transaction record 115 maintained by the blockchain system and have an agreement on what the overall transaction record 115 is. Each node 105 in the blockchain system may be referred to as a consensus node. The transactions may be cryptocurrency transaction such as Bitcoin transactions (represented by “TX . . . ” in FIG. 1). The overall transaction record 115 is where all the transactions processed through the blockchain system 100 is stored. The overall transaction record 115 is kept in the form of a blockchain. Node computers 105 in the blockchain system each has its own copy of the overall transaction record or blockchain 115. A node computer might have a different copy of the overall blockchain temporarily, but node computers will eventually agree on a same overall blockchain. For example, a node 105 might have a blockchain consisting of A, B, and C at time 1 and another node 105 might have a blockchain consisting of A, B, D at the same time. After a period of time, both nodes will both agree on an overall blockchain that consists of A, B, and C. Their copy of the blockchain will also be updated accordingly. The blockchain means a distributed ledger in which transactions are maintained across several node computers that are linked and immutable in a peer-to-peer network. Maintain means that each node computer has a local copy of the blockchain or transactions processed through the blockchain system and can update its local copy when new transactions or proposals are received in the blockchain system (such as using the notarization process described below).

The blockchain system 100 involves a committee of consensus nodes 120 which includes a plurality of proposer nodes and a plurality of voter nodes. Although FIG. 1 shows that there are two proposer nodes (P1 and P2) and three voter nodes (V1, V2, and V3), it is understood that the committee 120 may be made up of other number of proposer nodes and voter nodes. The committee 120 is configured to perform a propose and vote process (or notarization process). Nodes N1-Nn in FIG. 1 are nodes that submit transactions to the committee 120 for notarization. The submitted transactions are held in a memory pool (or transaction pool) to be picked up from a proposer node. A proposer node selects transactions from the memory pool and prepares an electronic block containing the selected transactions to be added to a blockchain. The prepared block may be referred to as a candidate block or proposal. The proposer node then signs the proposal and sends the signed proposal to the plurality of voter nodes V1, V2, V3.

A voter node is configured to vote or sign the proposal after it validates the proposal and when it and the proposer node have substantially the same freshest notarized chain (described below). When a proposal receives enough signatures from the voter nodes in the plurality, the proposal is notarized or added to the blockchain. The required number of signatures for notarization is preferably greater than 50% of the total number of voter nodes in the plurality but other numbers are also contemplated. This is a vote-by-seat scheme. Other voting schemes are also contemplated such as vote-by-stake scheme. In vote-by-stake scheme, the notarization threshold could be configured to be votes from voter nodes holding greater than 50% of stake in the committee. For example, if the committee includes six voter nodes and two of the six voter nodes hold greater than 50% of stake in the committee, votes from those two nodes are sufficient to have the proposal notarized (instead of four votes). The notarized proposal is then added to the freshest notarized chain, or the head of the freshest notarized chain (the block with the largest epoch). After notarization, the proposer node can then send another proposal to the voter nodes for notarization.

The blockchain system is configured to notarize proposals one at a time. In one embodiment, the proposer node is configured to transmit a proposal after enough signatures are received for the previous proposal (except the very first proposal when the block system is initiated which does not need such a requirement). In another embodiment, the proposer node is configured to transmit a proposal when it is its turn to propose. Whether it is the proposer node's turn to propose is determined by epoch (described below). In other words, the proposer node can propose regardless whether a proposal has received enough signatures (or any signature) as long as it is its turn to propose. In either embodiment, the proposer node sends out a proposal extending from its freshest notarized chain. A proposal before notarization means an unnotarized proposal.

The blockchain system employs epoch to facilitate the operation of the blockchain system and determine the length of the freshest notarized chain and other chains such as the notarized chain and finalized chain. Epoch herein refers to a time parameter that includes a value and defines a period of time. The value identifies the proposer node that sent the proposal. For example, when the value is 1, the proposer node that sent the proposal is proposer node 1. For example, when the value is 2, the proposer node that sent the proposal is proposer node 2. The value is also configured to increase sequentially and thus allow a different proposer node to send a proposal. For example, if the current value of epoch is 1, then that value may advance to 2 at a later time and allow proposer node 2 to send the next proposal (instead of proposer node 1). The epoch advances according to a node's local time (or synchronized local time) determined by a clock of that node. For example, the clock in a node (e.g., proposer node or vote node) might have a time of 1:00 pm and that time is associated with an epoch value of 1. When the clock has a time of 1:01 pm, that time is associated with an epoch value of 2, and so forth. Although the example shows that the epoch value advances every minute, it is understood that the epoch value can also advance in other frequency such as every 0.5 second (or smaller), 30 seconds, 5 minutes, 10 minutes, or other intervals. The clocks on the nodes can be synchronized by a network time protocol so that their time differences are within tens of milliseconds or within one millisecond in some conditions.

The period of time of the time parameter is a duration that is long enough for the committee to complete two rounds of communications, the transmission of a proposal to the voter nodes (propose round) and the signing of the proposal (vote round), including network delay and other latencies. The period of time may also be referred to as the maximum network latency. For example, if the duration is 10 seconds, then the committee would finish proposing a proposal and signing the proposal by the end of 10 seconds. The period of time can be determined based on the size of the network of the blockchain system (e.g., number of consensus nodes). For example, the duration may be 10 seconds for a small network such as a blockchain system including 50 consensuses nodes. For another example, the duration may be 15 minutes for a large network such as a blockchain system including 10,000 consensuses nodes.

By synchronize the clocks using the network time protocol, or allowing the blockchain system to propose and vote and defining a period of time that is long enough to complete the propose round and vote round of communications in the blockchain system, the blockchain system achieves synchrony or is referred to as a synchronous blockchain system.

In some embodiments, the propose round may further include the steps of selecting transactions from the memory pool and preparing selected transactions into a candidate block. In that situation, the duration may be defined to be long enough to cover those steps as well (and their network delay and other latencies).

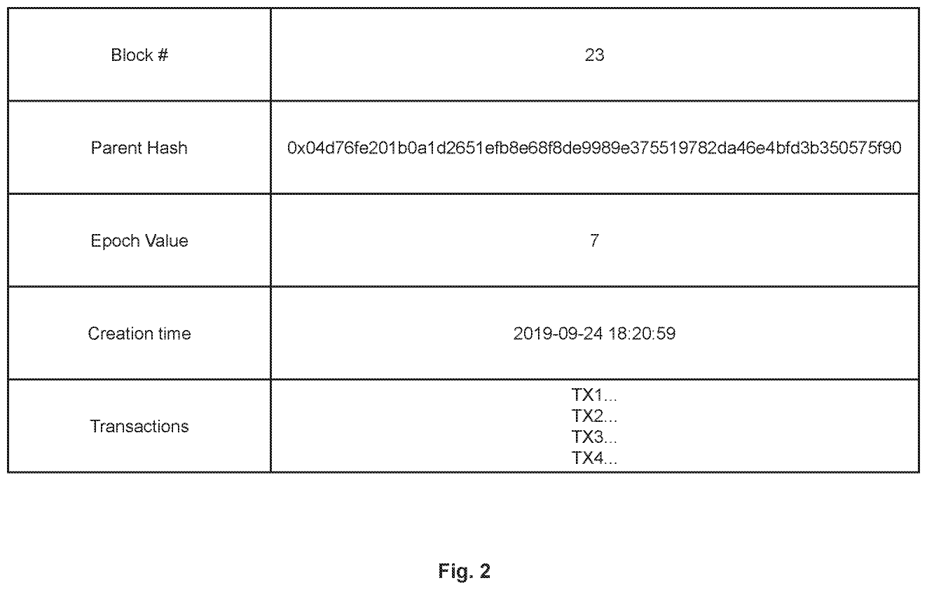

Each candidate block or notarized block includes an epoch value corresponding to the epoch in which it is proposed. For example, if a candidate block is proposed when the epoch value is 5, then the candidate block includes the epoch value 5. After the candidate block is notarized or successfully goes through the propose round and the vote round, the notarized block is added to the blockchain and is identified by that particular epoch value. As such, a blockchain built using this technique include blocks having monotonically increasing epoch values. For instance, the epoch value starts at 1 and allows the propose node 1 (associated with epoch value 1) to transmit a candidate block with the epoch value 1 to the voter nodes. After the candidate block is notarized, the notarized block is added to the blockchain and is identified by the epoch value 1. The epoch value then advances from 1 to 2 and allows proposer node 2 (associated with epoch value 2) to prepare and transmit the next proposal. FIG. 2 depicts an illustrative block including an epoch value provided by the blockchain system. The block shown in FIG. 2 may be a candidate block or a notarized block.

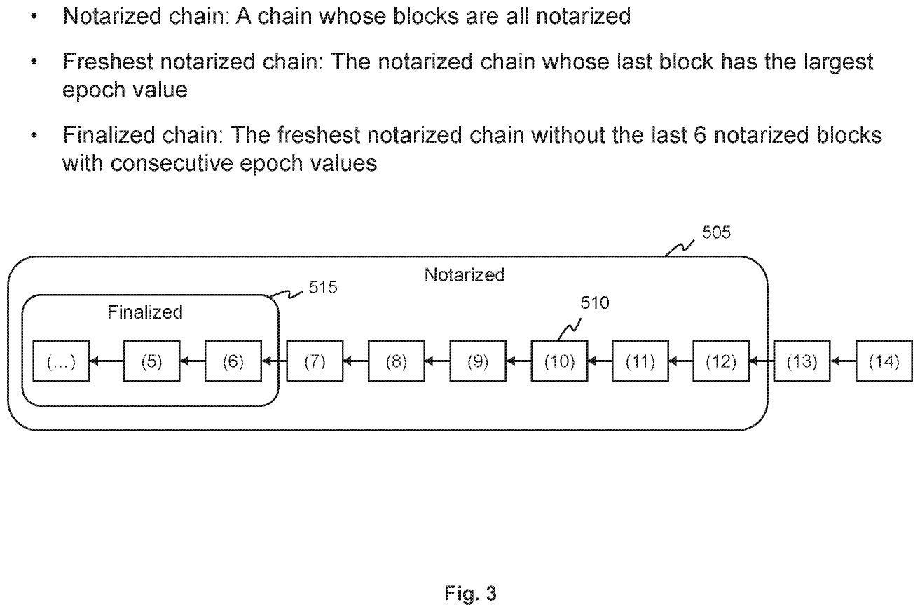

The freshest notarized chain refers to a notarized chain that has the largest epoch value. The block with the largest epoch value in the notarized chain may be referred to as the head block or simply the head. FIG. 3 depicts an illustrative freshest notarized chain 505. Chain 505 is the freshest notarized chain because its head block 510 has the largest epoch value 12. There may be other notarized chains that have observed by the node such as a notarized chain with a head block having epoch value 10 and another notarized chain with a head block having epoch value 11, but chain 505 is the freshest one since the epoch value of the head block in chain 505 is 12 or the largest.

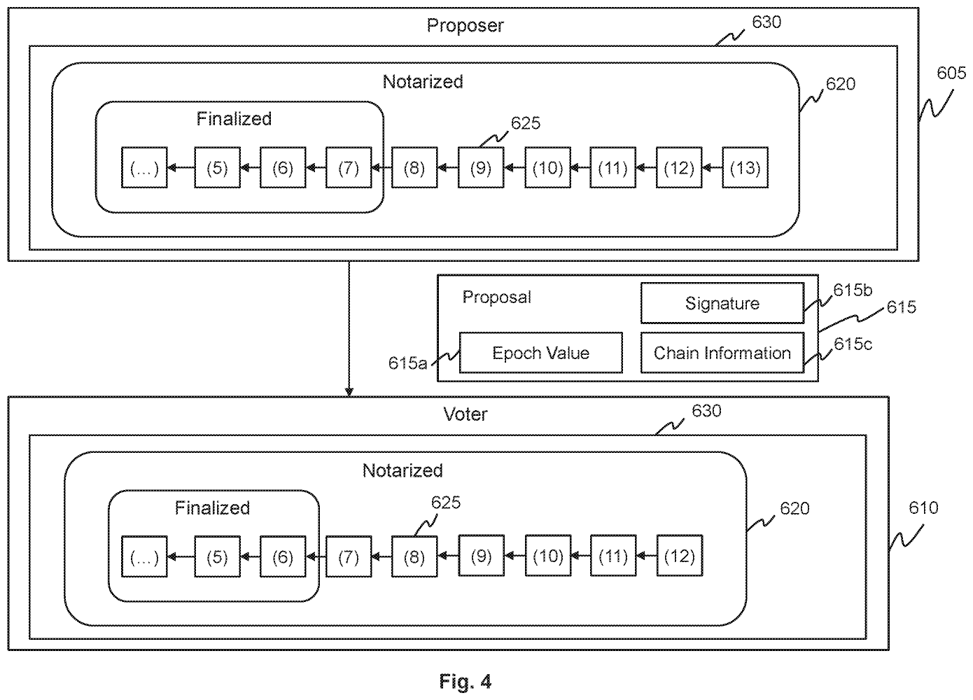

The freshest notarized chain or the head block of the freshest notarized chain is used to determine when the voter node would vote on a proposal. In one embodiment, the voter node votes on a proposal when the freshest notarized chain in the local record of the proposer node substantially matches that of the voter node, or when the head block of their freshest notarized chains substantially match. In some situations, their freshest notarized chains or heads might differ slightly but the voter node would still vote on a proposal. FIG. 4 illustrates this concept. The voter node 610 checks whether they substantially match when it receives a proposal 615 from the proposer node 605. The proposal 615 includes an epoch value 615a (e.g., 14), the proposer node's signature 615b, and chain information 615c providing information on the freshest notarized chain 620 or the head block of the freshest notarized chain 620 stored in the proposer node 605. Upon receiving the proposal 615, the voter node 615 uses chain information 615c to determine whether their freshest notarized chains 620 or the head blocks 625 of their freshest notarized chains 620 substantially match. The head block 625 in the voter node 610 is smaller than that of the head block 625 in the proposer node 605 (one block smaller). This may be caused by the proposer node 605 received another notarization and the blockchain information on the voter node 610 has not been updated yet. Since they differ by only one block or they substantially match, the voter node 910 can vote on the proposal 915. In some embodiments, the difference can be two or more blocks. In some embodiments, substantially match means that the epoch value of the head block in the proposer node is at least the same or greater than the epoch value of the head block in the voter node. In some embodiments, the freshest notarized chain in the local record of the proposer node and/or the freshest notarized chain in the local record of the voter node used by the voter node to make the determination is the freshest notarized chain the voter node observes in the previous epoch value, or the epoch value before the epoch value 615a. For example, if the epoch value 615a is 14, then the freshest notarized chain in the local record of the voter node is the one the voter node observes in epoch value 13. Substantially match may also refer to that the head block of the freshest notarized chain in the proposer node is as large as the head block of the freshest notarized chain in the voter node (referring to their epoch value). If the epoch value of the head block in the proposer node subsequently gets larger or slightly larger than that of the head block in the voter node, the voter node would still vote. In some embodiments, the epoch value of the head block in the proposer node can be smaller than that of the voter node.

It should also be understood from the above that the voter node would vote on a proposal when the freshest notarized chain in the local record of the proposer node matches exactly to that of the voter node, or when the head block of their freshest notarized chains match exactly. Matching exactly means that the epoch value of both head blocks match exactly (e.g., the epoch value of the head block on the proposer node is 8 and the epoch value of the head block on the voter node is also 8).

Blockchain information 620 in the proposer node 605 and voter node 610 may be stored in a volatile storage device (e.g., memory) or a non-volatile storage device (e.g., hard drive) 630. Chain information 615c, in one embodiment, is a pointer pointing to the head block of the freshest notarized chain in the propose node 605.

In addition checking whether the freshest notarized chains substantially match, the voter node 610 also checks signature 615b to ensure that the proposal 615 comes from the correct proposer or proposer 605 (e.g., if proposer 605 is the proposer node associated with the epoch value 615a).

A notarized chain refers to a blockchain whose blocks are all notarized pursuant to the propose and vote method described above. A finalized chain refers to the freshest notarized chain without a number of consecutive blocks having consecutive epoch values. The consecutive blocks refer to the latest consecutive blocks on the chain. In one embodiment, the number of consecutive blocks is 6 but other numbers are also contemplated. In FIG. 3, the freshest notarized chain is 505 and the finalized chain is 515. The freshest notarized chain 505 without or excluding the 6 latest consecutive blocks having consecutive epoch values is the finalized chain is 515. The same concept applies to the freshest notarized chains 620 and the finalized chains shown in FIG. 4. A finalized chain or finalized block is sent or published to a computer (e.g., N1 in FIG. 1) so that the computer or its user knows that the submitted transaction(s) successfully went through the blockchain system (e.g., the transactions added to the blockchain and are irreversible, or a crypto coin is removed from the cryptocurrency account of a user/consensus node and deposited into the cryptocurrency account of another user/consensus node and this record is irreversible). For example, the finalized chain or finalized block may appear as a series transactions or records on a display of the computer showing the submitted transactions and the digital signatures of the node computers that submitted the transactions. Submitted transactions may include payments or requests for payment.

A finalized block or chain means that the transactions in the block or chain is irreversible or immutable. The transactions therein stay permanently on the blockchain and cannot be revoked, discarded, or manipulated by any nodes on the blockchain system. A finalized block or chain is kept and agreed by every consensus node in the blockchain system. A finalized chain is a ledger that is identical to every consensus node in the blockchain system. A notarized block or chain may be considered as a block or chain waiting to be finalized.

In short, the blockchain system 100 involves a committee 120 of consensus nodes to add blocks to the overall blockchain 115 maintained by the blockchain system. The committee 120 conducts a propose and vote process to add blocks to the blockchain 115. The committee 120 includes proposer nodes and voter nodes, and they are configured to propose and vote proposals one at a time. The voter nodes V1, V2, V3 each will vote on a proposal after validation and when each voter node and the proposer node have substantially the same freshest notarized chain. A threshold number of votes (e.g., greater than 50%) is required to notarize the proposal. A notarized proposal is added to the blockchain and a notarized chain can be established or extended. A finalized chain is determined from the notarized chain.

The committee 120 of consensus nodes can be determined by an election scheme. In one embodiment of the election scheme, nodes that want to be committee members (either proposer nodes or voter nodes) submit bid transactions or election bids. Bid transactions are submitted in the form of blockchain transactions, which are similar to cryptocurrency transactions in the memory pool except that the underlying transactions are cryptocurrency amounts that the candidate nodes specified to be put in and locked up in an escrow for a committee term, and that these bid transactions are sent for committee election purposes (as opposed to proposal notarization). Candidate nodes also specify whether they want to be a proposer node or voter node in the bid transaction. The bid transactions may be prepared in a format or includes information that indicates that they are to be used for election purposes.

A committee term is a period of time in which an elected or selected node will serve as a proposer node or voter node. The period of time is measured by a number of blocks on a blockchain. After the committee term expires, the new selected nodes take over and serve new proposer nodes and voter nodes in the next committee term. For example, each committee term may be configured to last 10,800 blocks (e.g., after 10,800 are added to the blockchain which is approximately 3 hours if the blockchain system produces a block per second). Bid transactions submitted during the current committee term are used to determine the proposer nodes and voter nodes for the next committee term. The blockchain system can select candidate nodes with the highest amounts of stake to be the proposer nodes and voter nodes for the next committee term (e.g., top 2 proposer candidate nodes to be proposer nodes and top 3 voter candidate nodes to be voter nodes). The blockchain system can be configured to choose a number of highest stake nodes for proposer nodes and voter nodes. The blockchain system can be configured to pre-select the initial committee (without using an election scheme) and select the subsequent committees by the election scheme discussed above. The blockchain system can select the entire committee 120 for the next committee term or some committee members for the next committee term (e.g., only proposer nodes or voter nodes, only one of the proposer nodes, only one of the voter nodes, etc.). The blockchain system can also select a committee using a round robin policy. Other election schemes can also be used.

Embodiments of the present invention achieve consistency (e.g., all the consensus nodes will agree on the same blockchain) and liveness (e.g., transactions or blocks will be added to the blockchain and finalized quickly). Embodiments of the present invention can add a block to the blockchain every time the epoch value advances and finalize a block when a number of consecutive blocks with consecutive epoch values are added after that block. Traditional consensus systems and protocols can process approximately 10-20 transactions per second and finalize transactions in approximately 60-90 seconds, whereas consensus systems and protocols of the present invention can process approximately 1000 transactions per second and finalize transactions in approximately 10-20 seconds, and in some situations in 1-5 seconds. Some existing consensus systems and protocols do not even have a rule or process for finalizing a chain or block. Embodiments of the present invention can also tolerate minority Byzantine faults such as up to 33%. Other percentages may also be possible. In one implementation, the above performance has been achieved consistently when there is less than ⅓ of Byzantine voter nodes and there is at least one honest proposer and more than half of the voter nodes are honest. This performance also has been achieved consistently in other conditions.

A block refers to a block on a blockchain or a block to be added onto a blockchain so that it extends from the latest block from a blockchain. A block may include transactions, hash of the previous electronic block, hash of the current electronic block, a timestamp, Merkle root, target, nonce, and other information, or one or more of the aforementioned information. FIG. 2 depicts an illustrative block and it may include other data fields indicated above.

Signature or its equivalents from proposer node's perspective refers to a digital signature created by the proposer node proving that the proposer node is the creator or proposer of the candidate block. The digital signature is unique to each proposer node. For example, a digital signature can be created by hashing the transactions to obtain a hash value and encrypting the obtained hash value using a private key. The encrypted hash value is the digital signature. The digital signature and a public key corresponding to the private key are transmitted with the candidate block to a voter node.

After the voter node receives the candidate block, digital signature, and public key, the voter node decrypts the digital signature using the public key. The voter node is aware of the transactions that it is expecting from this block and hashes the transactions it is expecting using the same hash algorithms employed by the proposer node. If the hash value from the decryption of the digital signature and the hash value from the voter node are the same, then the voter node knows that the transactions have not been altered in transit and verifies that the proposer node is the creator, proposer, or transmitter.

Validation or its equivalent refers to that the voter node knows that the transactions have not been altered in transit and/or verifies that the proposer node is the creator, proposer, or transmitter. Validation or its equivalent may also refer to determining that the signature on the candidate block comes from the correct proposer node and/or the transaction data is correct.

After validating the proposal, the voter node applies its digital signature to the proposal (signing the proposal and voting the proposal are other synonymous languages). The concept of signature described above may also similarly apply to the voter node.

Other signature (by the proposed node or voter node) and validation methods are also contemplated. Signature and validation methods can be based on other processes known in the art.

A proposer node may also be referred as a leader node, and a committee node may refer to either a proposer node or a voter node. The committee of nodes, proposer nodes, and voter nodes are implemented with algorithms to perform their respective functions. The blockchain system and the blockchain consensus software application include such algorithms and algorithms for performing the notarization process, the election scheme, the freshest notarized chain determination process (and other chain determination process), and other processes and schemes described in this application. The initial committee may be determined by the blockchain system and blockchain consensus software application, such as from the codes the software developers program into the algorithms (e.g., specific proposer nodes and voter nodes selected by the software developers and the selected nodes are coded into the algorithms). The subsequent committee may be selected from an election scheme.

Honesty means that a node is performing what it is required to perform (e.g., executing the preparing, submitting, signing, and transmitting steps), that the transactions and/or epoch value are not manipulated by the node to add incorrect transaction data and/or change epoch value, or a combination thereof.

Being Byzantine means that a node is violating or is attempting to violate one or more of the above honesty requirements.

Transactions or transaction data may be cryptocurrency transactions (e.g., Bitcoin transactions), bank transactions, credit card transactions, and other transactions that involve paper money (e.g., an individual can obtain paper money from a bank). Transactions or transaction data may also be non-currency or non-monetary transactions, transactions used to create and call smart contracts, or other transactions used to perform other tasks. Transactions or transaction data may also be other types of data (e.g., computer instructions) or records (e.g., business records, medical records). Combinations of the aforementioned transactions, data, and records are also contemplated.

Protocols and algorithms described in this application are implemented on computers (e.g., node computers) that are connected by a communications network. The communications network can include the Internet, a cellular network, a telephone network, a computer network, a packet switching network, a wide area network (WAN), a global area network, or other network. Embodiments of the present invention are directed to systems, devices, and methods that perform the protocols and algorithms. Embodiments of the present invention are also related to a non-transient computer readable medium configured to carry out any one of the methods disclosed herein. The protocols and algorithms can be a set of computer instructions readable by a processor and stored on the non-transient computer readable medium. Such medium may be permanent or semi-permanent memory such as hard drive, floppy drive, optical disk, flash memory, ROM, EPROM, EEPROM, etc., as would be known to those of ordinary skill in the art. Block or blockchain information may be stored on the non-transient computer readable medium or the memory. Memory, for example, may be cache memory, semi-permanent memory such as RAM, and/or one or more types of memory used for temporarily storing data.

Processor may include an application specific integrated circuit (ASIC), programmable logic array (PLA), digital signal processor (DSP), field programmable gate array (FPGA), or any other integrated circuit. Processor can also include one or more of any other applicable processors, such as a system-on-a-chip that combines one or more of a CPU, an application processor, and memory, or a reduced instruction set computing (RISC) processor.

It is understood that embodiments of the present invention are computer-implemented systems or processes.

It will readily be understood by one having ordinary skill in the relevant art that the present invention has broad utility and application. Other embodiments may be discussed for additional illustrative purposes in providing a full and enabling disclosure of the present invention. Moreover many embodiments such as adaptations, variations, modifications, and equivalent arrangements will be implicitly disclosed by the embodiments described herein and fall within the scope of the present invention.

Accordingly, while the embodiments of the present invention are described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended nor is to be construed to limit the scope of patent protection afforded by the present invention, which scope is to be defined by the claims.

Thus for example any sequence(s) and/or temporal order of steps of various processes or methods (or sequence of system connections or operation) that are described herein are illustrative and should not be interpreted as being restrictive. Accordingly, it should be understood that although steps of various processes or methods (or connections or sequence of operations) may be shown and described as being in a sequence or temporal order, but they are not necessarily limited to being carried out in any particular sequence or order. Other sequences or temporal order is contemplated and would be understood to exist by those of ordinary skill in the art. In addition systems or features described herein are understood to include variations in which features are removed, reordered, or combined in a different way.

Additionally it is important to note that each term used herein refers to that which the ordinary artisan would understand such term to mean based on the contextual use of such term herein. It would be understood that terms that have component modifiers are intended to communicate the modifier as a qualifier characterizing the element, step, system, or component under discussion.

The words “may” and “can” are used in the present description to indicate that this is one embodiment but the description should not be understood to be the only embodiment.

Although the present invention has been described and illustrated herein with referred to preferred embodiments, it will be apparent to those of ordinary skill in the art that other embodiments may perform similar functions and/or achieve like results. Thus it should be understood that various features and aspects of the disclosed embodiments can be combined with or substituted for one another in order to form varying modes of the disclosed invention.

1. A system comprising:
a plurality of node computers, each node computer in the plurality including a processor, memory storing computer instructions executable by the processor, and a network interface operatively coupled to the processor and a communications network connecting the plurality of node computers, wherein the plurality of node computers are configured to create a blockchain containing transactions, the plurality of node computers includes a committee of node computers comprising proposer node computers and voter node computers;
wherein the system is configured to provide a time parameter to a proposal, the time parameter includes a value and defines a period of time, the value identifies a proposer node computer in the committee that sends a proposal and the period of time has a duration long enough for the committee to complete a notarization process;
wherein the committee is configured to perform a notarization process, and in the notarization process, the proposer node computer identified by the value of the time parameter is configured to prepare and send an unnotarized proposal, including transactions and a time parameter value in which the unnotarized proposal is sent, to the voter node computers in the committee, and each of the voter node computers in the committee is configured to sign the unnotarized proposal when the voter node computer has substantially the same record of the blockchain as the proposer node computer;
wherein the system is configured to notarize the unnotarized proposal after the unnotarized proposal receives a threshold number of signatures and add the notarized proposal with the time parameter value to the blockchain;
wherein the records being used to determine whether the voter node computer and the proposer node have substantially the same record are notarized chains that have the largest time parameter value; and
wherein the system is configured to determine a finalized chain from the notarized chain by excluding a number of consecutive blocks with constitutive time parameter values from the notarized chain and the finalized chain consists of blocks that are irreversible by node computers in the system.

2. The system according to claim 1, wherein the largest time parameter value of the notarized chain in the proposer node computer and the largest time parameter value of the notarized chain in the voter node computer are the same.

3. The system according to claim 1, wherein the largest time parameter value of the notarized chain in the proposer node computer is larger than the largest time parameter value of the notarized chain in the voter node.

4. The system according to claim 1, wherein the number of consecutive blocks excluded by the system is 6.

5. The system according to claim 1, wherein the system is configured to determine a finalized chain from the notarized chain by excluding a number of latest consecutive blocks with constitutive time parameter values from the notarized chain.

6. The system according to claim 1, wherein the system is configured to determine a finalized chain from the notarized chain by excluding 6 latest consecutive blocks with constitutive time parameter values from the notarized chain.

7. The system according to claim 1, wherein the threshold number of signatures is more than 50% of the total number of voter nodes in the committee.

8. The system according to claim 1, wherein the threshold number of signatures is equivalent to a number of voter notes that together holds more than 50% of the total stake in the committee.

9. The system according to claim 1, wherein the period of time is determined based on the number of node computers in the system.

10. The system according to claim 1, wherein the system is configured to advance the time parameter value after the period of time expires.

11. The system according to claim 11, wherein the voter node computers are configured to receive proposals from another proposer computer in the committee after the time parameter value advances.

12. The system according to claim 1, wherein the proposer computer nodes and the voter node computers are selected based on a round robin policy.

13. The system according to claim 1, wherein the system is further configured to send the finalized chain to a computer allowing the computer or the user of the computer to know that the transaction successfully went through the blockchain system.

14. The system according to claim 13, wherein the finalized chain appears as a series transactions or records on a display of the computer showing the submitted transactions and digital signatures of the node computers that submitted the transactions.

15. The system according to claim 1, wherein the transactions include cryptocurrency transactions, bank transactions, credit card transactions, non-monetary transactions, transactions used to create or execute computer instructions, or transactions based on a combination thereof.

16. A computer-implemented method comprising:
implementing a blockchain consensus software application in a plurality of node computers, each node computer in the plurality including a processor, memory storing computer instructions executable by the processor, and a network interface operatively coupled to the processor and a communications network connecting the plurality of node computers, the application configuring the plurality of node computers to create a blockchain containing transactions and to form a committee of node computers comprising proposer node computers and voter node computers;
wherein the blockchain consensus software application includes computer instructions stored in the memory that are executable by the processor to perform computer-implemented steps comprising:
providing a time parameter to a proposal, the time parameter includes a value and defines a period of time, the value identifies a proposer node computer in the committee that sends a proposal and the period of time has a duration long enough for the committee to complete a notarization process;
performing a notarization process comprising allowing the proposer node identified by the time parameter value to prepare and send an unnotarized proposal, including transactions and a time parameter value in which the unnotarized proposal is sent, to the voter node computers in the committee, allowing each of the voter nodes in the committee to sign the unnotarized proposal when the voter node computer has substantially the same record of the blockchain as the proposer node computer, notarizing the unnotarized proposal after the unnotarized proposal receiving a threshold number of signatures, and adding the notarized proposal with the time parameter to the blockchain;
wherein the records being used to determine whether the voter node computer and the proposer node have substantially the same record are notarized chains that have the largest time parameter value; and
determining a finalized chain from the notarized chain by excluding a number of consecutive blocks with constitutive time parameter values from the notarized chain, wherein the finalized chain consists of blocks that are irreversible by node computers in the system.

17. The method according to claim 16, wherein the largest time parameter value of the notarized chain in the proposer node computer is the same as or larger than the largest time parameter value of the notarized chain in the voter node.

18. The method according to claim 16, wherein the number of consecutive blocks excluded by the system is 6.

19. A non-transitory computer readable medium storing an application cause a computer to execute a process, the process comprising:
implementing a blockchain consensus software application in a plurality of node computers, each node computer in the plurality including a processor, memory storing computer instructions executable by the processor, and a network interface operatively coupled to the processor and a communications network connecting the plurality of node computers, the application configuring the plurality of node computers to create a blockchain containing transactions and to form a committee of node computers comprising proposer node computers and voter node computers;
wherein the blockchain consensus software application includes computer instructions stored in the memory that are executable by the processor to perform computer-implemented steps comprising:
providing a time parameter to a proposal, the time parameter includes a value and defines a period of time, the value identifies a proposer node computer in the committee that sends a proposal and the period of time has a duration long enough for the committee to complete a notarization process;
performing a notarization process comprising allowing the proposer node identified by the time parameter value to prepare and send an unnotarized proposal, including transactions and a time parameter value in which the unnotarized proposal is sent, to the voter node computers in the committee, allowing each of the voter nodes in the committee to sign the unnotarized proposal when the voter node computer has substantially the same record of the blockchain as the proposer node computer, notarizing the unnotarized proposal after the unnotarized proposal receiving a threshold number of signatures, and adding the notarized proposal with the time parameter value to the blockchain;
wherein the records being used to determine whether the voter node computer and the proposer node have substantially the same record are notarized chains that have the largest time parameter value; and
determining a finalized chain from the notarized chain by excluding a number of consecutive blocks with constitutive time parameter values from the notarized chain, wherein the finalized chain consists of blocks that are irreversible by node computers in the system.

20. The medium according to claim 19, wherein the largest time parameter value of the notarized chain in the proposer node computer is the same as or larger than the largest time parameter value of the notarized chain in the voter node.
